(19) United States
(12) Patent Application Publication
(10) Pub. No.: US 2002/0112013 A1
(43) Pub. Date: Aug. 15, 2002

(54) Method for generating commercial email communications while preserving Internet privacy

(76) Inventor: Fiona Walsh, Seattle, WA (US)

Correspondence Address: Bennet K. Langlotz P.C., 2850 SW Fairmount Blvd., Portland, OR, 97201, US

(21) Appl. No.: 09/870,969

(22) Filed: May 30, 2001

Related U.S. Application Data
(63) Continuation-in-part of application No. 09/781,742, filed on Feb. 12, 2001.

(51) Int. Cl. G06F 15/16; G06F 15/173; G06F 17/60

(52) U.S. Cl. 709/206; 709/224; 709/227; 705/14

(57) ABSTRACT

A method of commercial Internet-based communication. The method includes a first entity such as a web merchant receiving an email or other address from a user. The first entity transmits a unique identifier associated with the user to a second entity, while the entity maintains the user communication address in secrecy from a second entity. The second entity accesses a database containing past Internet activity information associated with a multitude of Internet users, and determines a past Internet activity associated with the user's unique identifier. Based on the past activity of the user, the second entity communicates to the first entity whether a direct communication to the user is warranted, and if so, transmits information about a recommended communication such as a promotional emailing. The first entity sends such a communication to the user's communication address.

### REFERENCE TO RELATED APPLICATION

This is a continuation-in-part of U.S. patent application Ser. No. 09/781,742, filed Feb. 12, 2001, entitled METHOD AND FACILITY FOR PRESERVING INTERNET PRIVACY.

### FIELD OF THE INVENTION

This invention relates to internet communication, and more particularly to commercial and advertising communication methods that employ detailed user activity information while preserving user privacy.

### BACKGROUND AND SUMMARY OF THE INVENTION

The Internet is an effective tool for commercial communication. Companies use electronic communications to consumers to cost effectively promote their goods or services. A customer may provide his contact information to a company so that he or she may be sent promotional communications. The contact information may be an email address, a physical street address, a telephone number, or any other information that allows the company to transmit promotional information or advertisements.

Companies can improve the effectiveness of their promotions by targeting or tailoring them to the particular customers. Internet companies can readily gather limited anonymous information from visitors to digital properties (such as web sites), including recording the pages and advertisements viewed by the user, along with any other IP based activity (this covers HTTP (internet), smtp, and other IP based protocol). This information may be collected over time, from visits to many different digital properties, and may paint a detailed anonymous portrait that is useful in determining whether and with what promotional content to communicate. Such browsing information gathered about the user's browsing and other Internet activity lacks the means to contact the user. The gathered information is identified by a unique device identifier such as a “cookie” associated with either the device (if there are no profiles on the device) or the user's profile on the device used by the user for browsing, but this cookie does not identify the user, his email address, or any other information. IN the preferred embodiment, this is merely a numeric identifier that is useful for identifying all the different browsing sessions conducted by the same user in domains where the communication service company is serving content into, and it is impossible to determine from the identifier the identity or location of the person using the device. Once assigned the identifier may also be used so that subsequent visits may be correlated with earlier visits to identify patterns, or to select which advertisements are served to the still-anonymous visitor.

Therefore, it is necessary for a web site operator seeking to later contact a user to invite the user to voluntarily provide address or other contact information. Once provided, the address is associated with the cookie or other persistent identifier in the database of the company or its agent, enabling transmission to that address of communications selected based on the browsing data associated with that user's device.

While this approach is effective, some users are concerned about privacy issues. Even a user who trusts a particular familiar company not to disclose or misuse address information under normal circumstances may have concerns in the web browsing context. This concern can arise because of the body of data collected on his or her web browsing activity across many sites, which may then be connected to his or her personal identifying information. It is even possible that the user may wish to receive information from an organization he does not entirely trust (such as a person seeking information about sensitive medical or financial questions.) Consequently, many potential customers opt not to provide their contact information, and companies lose these commercial opportunities that those customers would otherwise have desired. Accordingly, there is a need for a system that allows companies to collect personal information needed to send messages, without the user being required to trust the company with that information.

The present invention overcomes the limitations of the prior art by providing a method of commercial Internet-based communication. The method includes a first entity such as a web merchant receiving an email or other address from a user. The first entity transmits a unique identifier associated with the user to a second entity, while the entity maintains the user communication address in secrecy from a second entity. The second entity accesses a database containing past Internet activity information associated with a multitude of Internet users, and determines a past Internet activity associated with the user's unique identifier. Based on the past activity of the user, the second entity communicates to the first entity whether a direct communication to the user is warranted, and if so, transmits information about a recommended communication such as a promotional emailing. The first entity sends such a communication to the user's communication address.

### BRIEF DESCRIPTION OF THE DRAWINGS

FIG. 1 is a schematic block diagram showing the system and method of operation according to a preferred embodiment of the invention.

FIG. 2 is a schematic block diagram showing the system and method of operation according to an alternative embodiment of the invention.

### DETAILED DESCRIPTION OF A PREFERRED EMBODIMENT

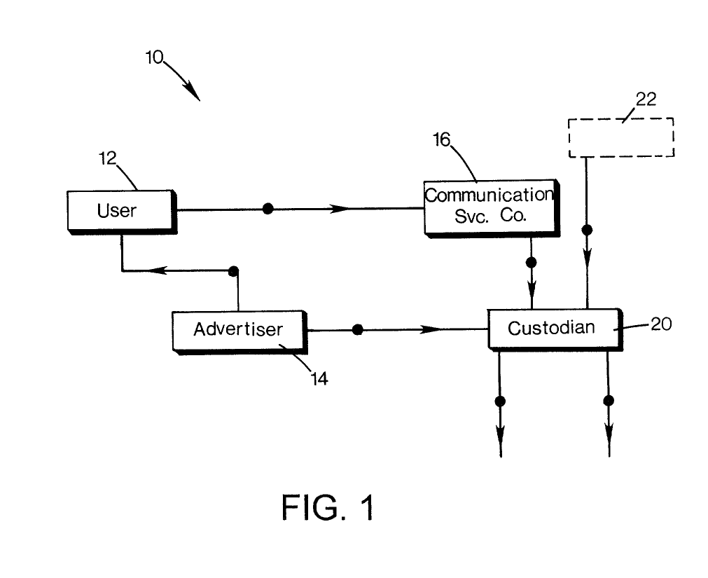

FIG. 1 shows an electronic communication system 10, operating in the environment of the Internet or other communication network. The diagram shows an Internet customer or user computer system 12. The Internet customer preferably uses one such Internet customer computer system to connect, via the Internet, to an Internet publisher or advertiser computer system 14, to retrieve and display a Web page.

Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities. When entities are described as being connected to the Internet, it is understood that the company maintains computer servers and other suitable equipment for communicating with other entities via the Internet.

An Internet communication service company (CSC) 16 is also connected to the Internet, and provides certain services to the advertisers and publishers. Such services may include placement of advertisements on the publisher's digital property, consulting services for placement of the advertiser's advertisements on other advertising digital properties, and collection and analysis of information about the advertisers and publishers customers and visitors to the advertisers and publishers digital properties. Advertisements may come in various formats, such as email text, email html, banner, globe etc. Publishers may sell space on various media, such as email, web pages, search results, newsletters etc.

A custodian company 20 is connected to the Internet for communication with the communication service company 16 and the publisher 14. The custodian maintains a secure database that is inaccessible to other entities, so that private and personal information transmitted to and stored by the custodian is inaccessible to all other parties, and may be utilized directly only by the custodian.

Each entity in the above system typically includes one or more central processing units (CPUs) for executing computer programs such as the facility described below, a computer memory for storing programs and data, and a computer-readable media drive, such as a CD-ROM drive, for reading programs and data stored on a computer-readable medium.

While preferred embodiments are described in terms of the environment described above, those skilled in the art will appreciate that the facility may be implemented in a variety of other environments, including a single, monolithic computer system, as well as various other combinations of computer systems or similar devices.

The process of operation of the facility involves the visit by the user 12 to the advertiser's 14 digital property, the user being invited to provide address information to enable the advertiser to send future promotions, the collection of web browsing data from the user by the communication service company 16, and the transmission of the personal data to the custodian (typically via the advertiser, which initially collects the personal data). A message is later generated to the user based on the collected web browsing data, and the custodian essentially addresses that message to the user by generating and transmitting a message using the personal data provided by the customer.

First, a user visits the advertiser's digital property. In one example, the advertiser may be an Internet retailer, and the user is browsing the site looking at various product offerings. The user may make multiple visits to the site. During these visits, the user is essentially anonymous, in that the site has no way of knowing who is visiting the site, where their computer is located, what is the user's email of street address, or any other personally identifiable information (PII). The site (publisher or advertiser) (or its agent 16) is able to collect very detailed information about the user's web browsing activity within the their own domain. However, this is identified only with either the unique device identifier (e.g. cookie) associated either with the user's profile on the browsing device or with the user's browsing device, or preferably, by a Communication Service Company ID (CSCID) generated by the CSC, and transmitted to the user's computer, where it is stored for use by the CSC to identify the user's computer on subsequent visits, to any digital property with which the CSC is associated.

Thus, the advertiser, publisher, or CSC may recognize that the same user (of unknown identity) has returned to their domain for a second visit, for instance. And the communication service company may collect this same data in conjunction with the advertiser or publisher, and index it in a database based on the CSCID or cookie, so that the user's visits to innumerable other digital properties of other advertisers and publishers are cataloged based on the one CSCID or cookie. Eventually a detailed portrait of the user (or at least of all users of that particular user's computer (if all users on the computer share the same profile) is generated. This portrait, even though it is still not identified with any particular identifiable user, may contain information useful to the advertiser or publisher for marketing purposes, but which is useful for generating promotional messages to the user only if a contact address can be associated with the information.

The advertiser or publisher requests such a contact address of the user. The request may come initially, such as when a user is required to register before gaining entry to a site (e.g. for downloading newspaper articles from a national newspaper site.) The request may come after the user has actively browsed, such as when providing shipping and billing address information for an on-line retail purchase. In any event, the provision of this personal information is purely voluntarily, and the user is well aware that the information is being collected, by whom and will be used to contact the user. This is considered an “opt-in” system, in which the user must take positive action before knowingly transmitting the personal information.

The personal information may include name, street address, email address, user URL, telephone numbers, and any other identifier useful for getting a communication to that user.

When the user opts in on a advertiser's or publisher's site to accept email, his history of anonymous web browsing activities and click stream that the communication service company (and/or others) has captured or gathered may be employed to generate messages to that user.

The advertiser or publisher (or its selected agent such as the CSC) receives the personal information. The LUID serves to identify the user, and is associated with the personal information by the advertiser or publisher. When the user's computer and browsing software requests a page to be downloaded, the page loads with the content from the advertiser or publisher and the action tag content that points the user's browser to the communication service company's domain, then the user opts in and submits their communication data to the advertiser or publisher, the advertiser or publisher saves the communication data associated with that user's the advertiser or publisher LUID, the advertiser or publisher programmatically appends the LUID to the CSC extended data action tag and then this data is submitted to the CSC server. With this communication of the LUID, the user's CSCID or device cookie is also collected, if it has not already been collected.

The communication service company now stores the LUID in a database record with the cookie, and with all browsing activity associated with the cookie, so that all the information is associated (excluding the personal information, which the publisher has not communicated to the communication service company.) By receipt of the LUID generated by the publisher, the CSC knows that there is contact address information now in existence (at the custodian) for a user associated with the cookie or CSCID under which profile information is stored.

The publisher then transmits the user's personal information together with the associated LUID to the custodian, either immediately, or in an occasional bulk transmission of user data. The custodian stores each user's information, indexed by the LUID, in a secure database to which no outside parties have access.

The system has now completed its gathering and storage of user information. Further browsing activity information by the user may be collected by the CSC, and stored with other information associated with the CSCID, until a satisfactory profile of the user is generated. The CSC uses the CSCID to access the user's anonymous browsing profile, and creates segments of users based on their anonymous browsing profiles. These segments preferably have common characteristics of browsing history that suggest that a particular promotional communication will be fruitful. For instance, users who are identified as having browsed and shopped at a retailer, selecting items for a “shopping cart”, but never having made the purchase, might be targeted with an email offering them the selected items at a discount. Innumerable alternative marketing strategies may be employed.

For each user selected to receive a given promotion, the CSC identifies the CSCID, and looks up the associated LUIDs. The CSC generates a communication package to the custodian. The package may be in the form of the message content, plus the list of the LUIDs of all who are the intended recipients. In this case, the custodian essentially serves as a mailing service, looking up the personal address information associated with each LUID, and sending the message content to that address. This approach is useful when each user receives a custom message, each of which might relate to a different particular item or discount level based on past recorded activity. Where the users in the segment are all selected to receive the same message, the custodian need not receive the message, but may instead receive the list of LUIDs from the CSC, and return a list of address information (such as email addresses.) This returned list is arranged in no particular order, and must be of adequate size so that it would be impractical to guess at which LUID correlates with which personal address information. A CSC and custodian may establish minimum standards for group size needed to adequately assure anonymity.

The CSC can enhance its database of user profiles by receiving more digital data from other CSCs 22, publishers, and other entities. These may include digital call centers, other online companies or other online publishers. By using extended action tags the CSC can link different LUIDs for the same user across different domains. So for each user, the information collected by one entity from one domain may be linked to other information received by another entities on another domains. For instance, an email received from one publisher may be linked to a telephone number, name, or street address from another publisher. Then, a single publisher or CSC desiring a promotion may use information provided to a different publisher (e.g. sending a postcard to an online customer who gave only his email address to the particular publisher, but who gave the street address to another publisher.)

In addition, the custodian may link the user's anonymous activity information across multiple different platforms (e.g. web browsing from various locations, wireless telephone, etc.)

The custodian may also offer internet enhanced profiles to other companies (catalog companies, call centers, online companies etc.) For example, a name, address, phone number, or credit card number may be used to link a user's digital profile to it's old world profiles in call centers and catalog companies. Thus, a call center could hand over a list of customer LUIDs to the CSC, which could inform advertisers which of their customers have hit their online site or their competitors online site and so the call center could then call the customer and encourage them to shop on line by offering them a discount. Also, by combining offline and online behavior, this data may provide valuable commercial insights to advertisers and/or publishers.

Preferably, to enhance a user's awareness of the trustworthiness of the above system, and particularly of the custodian (or CSC and/or publisher associated with the custodian), a symbolic indicia is displayed by the publisher on the web page at which personal information is requested. The indicia preferably includes textual or symbolic indicators of trust, safety, security, and/or privacy, and may be identified as a certification mark to ensure that the good will and reputation for trustworthiness and security accrues only to the entities involved, or to entities who meet the standards established by a certifying agency.

### Alternative Embodiment

An alternative embodiment of the invention operates as a two-party system, without a third party custodian for collecting personal data. In this embodiment, the Advertiser (typically an Internet retailer) collects and stores the personal address data, and uses this data to send communications such as promotional email to users. The selection of which users are to receive messages and/or the content of such messages, is based on an analysis of the user's historical web browsing activity by the Communication Service Company 16. The CSC, without knowing the user identities or address information, tells the advertiser or Advertiser 14 which users should receive which messages. The Advertiser then sends the users the messages, without knowing what detailed private web browsing data led to that selection and decision. Normally, the Advertiser is a client of the CSC, which serves advertisements for the advertiser at various Publisher sites on the web. However, the Advertiser may be any Internet entity that collects personal address information from users, and desires analysis of those users' web browsing or other activities to generate effective communications.

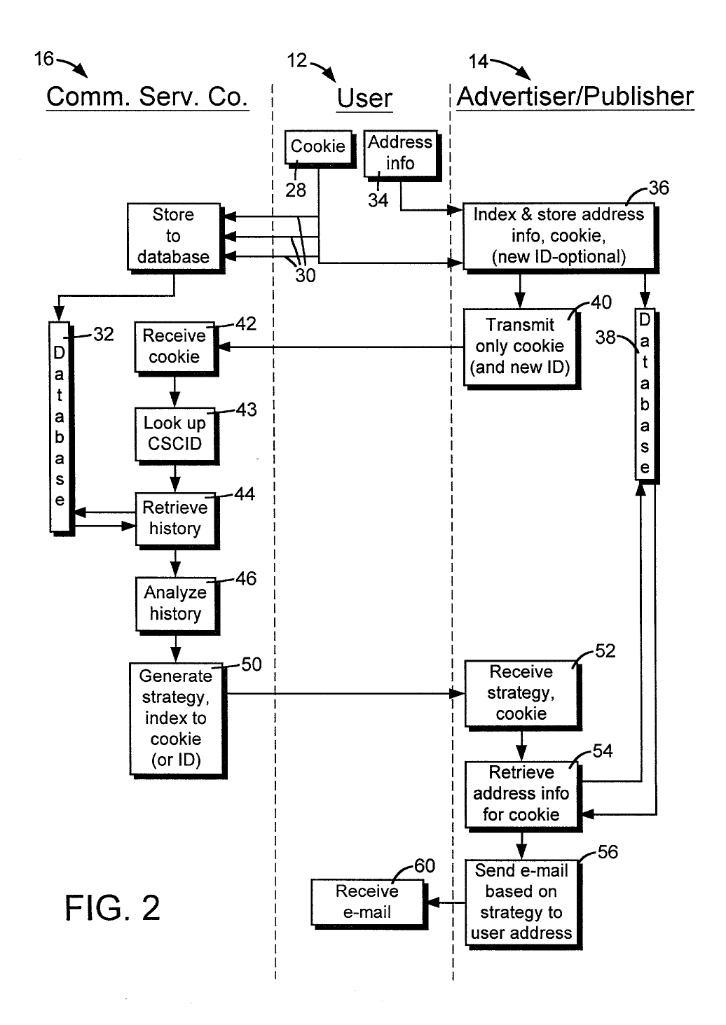

FIG. 2 shows a flow chart of operations of the two-party system. The two parties are the CSC 16 and the Advertiser 14, with communications occurring between these two parties, as well as with the user 12. In alternative embodiments, any party may delegate some or all of its tasks to an agent. The user is operating a computer or other communications device to communicate with the Advertiser and CSC. This device has a unique device identifier or cookie 28 that is received by an entity with whom the user communicates. The user may also be assigned an identifier or CSC cookie by the CSC (“CSCID”), and with the identifier or cookie stored on the user's device. Each time the user visits a web site of the Advertiser, or any web site on which the CSC has arranged to serve advertisements, the Advertiser or CSC receives their respective cookies. As a result, multiple visits by the user (or by any user of the same machine) may be correlated, and stored together or commonly indexed in a database.

In the illustrated embodiment, the user has multiple visits to web sites on which the CSC is serving ads. Each of these visits leads to a transmission 30 of the user's CSCID to the CSC. The CSC stores in a database 32 the information about each visit (e.g. site visited, page visited, whether a purchase was made, time of day, date, partial Internet Protocol (“IP”) address, advertisement seen) along with the CSCID, so that all such browsing activity is indexed by the CSCID in a database of the CSC. While this stored anonymous user profile data may be extremely detailed, and contain information that some might consider private, there is no personal identifying information transmitted to the CSC that could be used ever to identify or locate the individual who engaged in the browsing activities.

The user then visits the Advertiser's web site and engages in browsing activities. This may generate transmissions of information to the CSC and/or to the Advertiser, in conjunction with a selected, unique identifier generated by the Advertiser. This selected unique identifier may be the cookie assigned to the user by the Advertiser, or any other identifier such as a customer ID number generated by the Advertiser. The selected identifier should not be anything that contains personally identifying information, so that a recipient of the identifier would not be able to determine the user's actual identity. At some time during the browsing, the Advertiser invites the user to provide his address information 34, such as an email address, although it may be any other means for identifying the user for directing communications, such as a mailing address or telephone number. When the information is provided, the Advertiser indexes it in step 36, and stores it securely in a database 38, in a record including that selected unique identifier. During a time interval, many users may visit the Advertiser, and a multitude of addresses collected.

After a period of time, or after a certain number of addresses are collected, or at any time the Advertiser wishes to generate a promotional communications to its users, it transmits a set of data to the CSC for analysis in step 40. In certain embodiments, this transmission may be made separately for each user, such as for campaigns in which a promotional communication is desired immediately after the user offers the address information. In such cases, the CSC analysis serves to determine whether the user merits a promotional communication, and if so, what communication content is indicated. The data set transmitted to the CSC by the Advertiser includes the Advertiser's selected, unique identifier known to the CSC, for reference to the CSC's existing database. The data set may also include other anonymous demographic or behavioral data collected the Advertiser to help later analyses. Any of the device and assigned cookies, or other assigned ID numbers may be used by either party, as long as there is a common identifier used by both parties in their communications, so that each may identify to the other an individual about whom they have collected data, without transmitting personally identifying data.

The CSC receives the Advertiser's anonymous, selected unique identifier (as noted above) in step 42, and looks up the CSCID for that user in step 43. The CSC then retrieves historical web browsing activity from the database in step 44. The historical web browsing activity may include other communication or commercial activity associated with the CSCID, and not just web browsing. The historical information is analyzed in step 46. The analysis may include an indication of sites visited, purchasing patterns, browsing patterns, and other information from which conclusions may be drawn about the user's propensity to purchase the Advertiser's offerings, or what types of promotions may be most effective. Based on this, a strategy 50 is generated for the user. In selecting a strategy, the user may be placed into one of several different categories or segments. One segment may indicate that no communication is to be sent, others may include different types of communications, such as promotional discounts of different types or magnitudes. If a group of users is being analyzed in a single batch, the group may be segmented into the different categories of treatments. To preserve privacy, and to ensure that neither party can divine more detailed information about the user than is permitted, the process proceeds in batches of at least a minimum size.

The CSC indexes each cookie or other identifier to a prescribed treatment, and transmits the prescription and each associated cookie back to the Advertiser. In one approach, the CSC may actually generate the communication, and send it back for addressing by the Advertiser, analogous to composing and printing letters, and placing them in envelopes for addressing by the Advertiser. In another approach, the CSC may transmit more limited information about the users, such as whether they are in a category of future purchasers, high dollar purchasers, increasingly loyal purchasers, or potential customers for a particular category of goods, for instance, so that the Advertiser can generate its own message.

The Advertiser receives the strategy 52, indexed for each cookie or other identifier, and generates a message for each, if necessary. To prepare to transmit the message, the Advertiser looks up the address for each user to whom a message is to be sent in step 54, and sends the addressed message 56 to each users, who receives it in step 60.

Throughout the process, the CSC maintains its database of cookie-indexed web browsing histories in secrecy from the Advertiser. The Advertiser maintains its database of user address information in secrecy from the CSC.

If desired, third parties may be used to provide some of these services, as long as no party is entrusted with both historical browsing data and personal address data. Third parties may include data partners that have additional enhanced anonymous data based on the ID or cookie, and which can assist in generating more refined profiles and strategies.

While the above is discussed in terms of preferred and alternative embodiments, the invention is not intended to be so limited.

1. A method of commercial Internet-based communication with a user, comprising:
a first entity receiving from the user a user communication address;
the first entity transmitting a unique identifier associated with the user to a second entity;
the first entity maintaining the user communication address in secrecy from the second entity;
the second entity accessing a database containing past Internet activity information associated with a multitude of Internet users, and determining a past Internet activity associated with the unique identifier;
based on the past activity of the user, the second entity communicating to the first entity whether a direct communication to the user is warranted; and
if direct communication is warranted, the first entity sending a direct communication to the user communication address.

2. The method of claim 1 wherein the user communication address is an email address.

3. The method of claim 1 including the first entity establishing the unique identifier, and associating the identifier with a unique device identifier assigned to the user by the second entity.

4. The method of claim 3 wherein transmitting the unique identifier includes transmitting the device identifier.

5. The method of claim 1 including the first entity transmitting the unique identifier for a plurality of users, and the second entity based on the past activity of the users, identifying a subset of the users to receive a selected treatment.

6. 5 including the second entity transmitting to the first entity a report listing the unique identifiers associated with the users to receive the selected treatment.

7. The method of claim 1 wherein the database containing past Internet activity information associated with a multitude of Internet users is maintained to exclude user communication addresses.

8. A method of facilitating commercial Internet-based communication with a plurality of users, comprising:
receiving from an Internet publisher a communication including a plurality of unique user identifiers, each associated with one of the users;
accessing a database containing a record of past Internet activity information for each of the users;
retrieving the associated record for each user;
for each user, based on the record, selecting a communication strategy;
transmitting a report to the publisher identifying, for at least a plurality of the users, the unique user identifier and the selected communication strategy.

9. The method of claim 8 wherein the selected communication strategy includes a proposed email message.

10. The method of claim 8 wherein receiving a communication includes receiving a unique device identifier associated with the unique identifier, and associating the identifier with a unique device identifier previously assigned to the user by the second entity.

11. The method of claim 8 wherein the database containing past Internet activity information associated with a multitude of Internet users is maintained to exclude user communication addresses.

12. The method of claim 8 wherein the publisher collects and secretly maintains user address information, and addresses a communication to the user based on the user address information, and establishes the content of a message to the user based on the selected communication strategy.

13. A method of generating email messages based on past web browsing activity by users, comprising:
a web publisher collecting a user communication address and a device cookie from a user visiting a web site of the web publisher;
the publisher generating a unique anonymous identifier for the user;
the web publisher storing the user communication address in conjunction with the identifier;
the publisher transmitting the identifier and the device cookie to a second entity that maintains a database of past web browsing activity associated with the cookie, the database contents being maintained in secrecy from the publisher;
the publisher retaining the user communication address in secrecy from the second entity;
the second entity analyzing the past web browsing activity associated with the user's cookie;
based on the past web browsing activity of the user, the second entity communicating to the publisher the unique anonymous identifier and an associated proposed communication strategy;
based on the unique anonymous identifier, the publisher looking up the user communication address, and
the publisher sending a message having content based on the proposed communication strategy to the user communication address.

14. The method of claim 13 including the publisher generating message content for the user based on the proposed communication strategy.

15. The method of claim 13 wherein the message content includes message text for transmission to the user.

16. The method of claim 13 wherein the publisher storing the user communication address includes indexing the address in a database based on the unique anonymous identifier, and looking up the user communication address includes locating the unique anonymous identifier in the database.

17. A method of generating email messages based on past web browsing activity by users, comprising:
a web publisher collecting a user communication address and a device cookie from a user visiting a web site of the web publisher;
the publisher storing the user communication address in conjunction with the cookie;
the publisher transmitting the cookie to a second entity that maintains a database of past web browsing activity associated with the cookie, the database contents being maintained in secrecy from the publisher;
the publisher retaining the user communication address in secrecy from the second entity;
the second entity analyzing the past web browsing activity associated with the user's cookie;
based on the past web browsing activity of the user, the second entity communicating to the publisher the cookie and an associated proposed communication strategy;
based on the cookie, the publisher looking up the user communication address, and
the publisher sending a message having content based on the proposed communication strategy to the user communication address.

18. The method of claim 17 including the publisher generating message content for the user based on the proposed communication strategy.

19. The method of claim 17 wherein the message content includes message text for transmission to the user.

20. The method of claim 17 wherein the publisher storing the user communication address includes indexing the address in a database based on the cookie, and looking up the user communication address includes locating the cookie in the database.
